(19) United States
(12) Patent Application Publication
(10) Pub. No.: US 2014/0045056 A1
(43) Pub. Date: Feb. 13, 2014

(54) NON-AQUEOUS ELECTROLYTE SECONDARY BATTERY

(71) Applicant: Sanyo Electronic Co., Ltd, Osaka (JP)

(72) Inventors: Shinichi Yamami, Kasai City (JP); Toshikazu Yoshida, Kasai City, (JP); Toyoki Fujihara, Kanzaki-gun (JP); Toshiyuki Nohma, Kobe City, (JP)

(21) Appl. No.: 13/942,917

(22) Filed: Jul. 16, 2013

(30) Foreign Application Priority Data
Aug. 9, 2012 (JP) 2012-177186

(51) Int. Cl. H01M 10/0561

(52) U.S. Cl. CPC H01M 10/0561
USPC 429/199; 429/188

(57) ABSTRACT

To provide with high productivity a non-aqueous electrolyte secondary battery having superior battery characteristics and a high capacity.

The present invention is a non-aqueous electrolyte secondary battery including a negative electrode and a non-aqueous electrolyte. In this non-aqueous electrolyte secondary battery, the non-aqueous electrolyte includes lithium bis(oxalato)borate and/or lithium difluorophosphate, the negative electrode has a negative electrode core and a negative electrode active material layer formed on the negative electrode core, a negative electrode protecting layer including insulating inorganic particles is provided on the surface of the negative electrode active layer, the porosity of the negative electrode protecting layer is equal to or greater than the porosity of the negative electrode active material layer, and the battery capacity of the non-aqueous electrolyte secondary battery is equal to or greater than 21 Ah.

### CROSS-REFERENCE TO RELATED APPLICATIONS

This application claims the benefit of Japanese Patent Application No. 2012-177186 filed Aug. 9, 2012, the disclosure of which is herein incorporated by reference in its entirety.

### FIELD OF THE INVENTION

The present invention relates to a non-aqueous electrolyte secondary battery and, more specifically, to an improvement in the battery characteristics of a non-aqueous electrolyte secondary battery.

### BACKGROUND

Battery-powered vehicles with a secondary battery power supply, such as electric vehicles (EV) and hybrid electric vehicles (HEV), are becoming increasingly popular. However, these battery-powered vehicles require high-output/high-capacity secondary batteries.

Non-aqueous electrolyte secondary batteries, such as lithium ion secondary batteries, have a high energy density and a high capacity. The positive electrode and negative electrodes have an active material layer provided on both sides of the electrode core, and the positive electrode and negative electrode are wound together or laminated on each other via a separator to form an electrode assembly. This electrode assembly increases the opposing surface area between the positive and negative electrodes, and facilitates the extraction of a large current. As a result, non-aqueous electrolyte secondary batteries using a wound or laminated electrode assembly are used for this purpose.

In Patent Document 1, a technology related to a collector structure for stably extracting current from a high-output battery has been proposed.

### PRIOR ART DOCUMENTS

### Patent Documents

[Patent Document 1] Published Unexamined Patent Application No. 2010-086780

The technology disclosed in Patent Document 1 is a rectangular secondary battery in which a first current collecting plate is arranged in a first electrode core collecting area from which first electrode cores laminated directly on top of each other protrude. The first current collecting plate is resistance-welded on a surface parallel to the plane on which the first electrode cores are laminated. In this secondary battery, a first electrode core melt-attachment portion to which the first electrode cores are melt-attached is formed in an area separate from the area in which the first current collecting plate is attached.

### SUMMARY

### Problem Solved by the Invention

In addition to a better collector structure, vehicle-mounted batteries also require improved productivity and battery characteristics, such as output characteristics and cycle characteristics. However, these points are not considered in Patent Document 1.

In view of this situation, an object of the present invention is to provide with high productivity a non-aqueous electrolyte secondary battery having superior battery characteristics and a high capacity.

### Means of Solving the Problem

In order to solve this problem, the present invention is a non-aqueous electrolyte secondary battery including a negative electrode and a non-aqueous electrolyte, the non-aqueous electrolyte secondary battery characterized in that the non-aqueous electrolyte includes lithium bis(oxalato)borate (LiB(C₂O₄)₂) and/or lithium difluorophosphate (LiPO₂F₂), the negative electrode has a negative electrode core and a negative electrode active material layer formed on the negative electrode core, a negative electrode protecting layer including insulating inorganic particles is provided on the surface of the negative electrode active layer, the porosity of the negative electrode protecting layer is equal to or greater than the porosity of the negative electrode active material layer, and the battery capacity of the non-aqueous electrolyte secondary battery is equal to or greater than 21 Ah.

Lithium bis(oxalato)borate and/or lithium difluorophosphate are added to a non-aqueous electrolyte. These increase the input/output characteristics, cycle characteristics and low temperature output characteristics of the battery. However, when lithium bis(oxalato)borate and/or lithium difluorophosphate are added to the non-aqueous electrolyte, the viscosity of the non-aqueous electrolyte increases, and the non-aqueous electrolyte penetrates into the negative electrode active material layer with difficulty. Because the size of the negative electrode active material layer is especially large in the case of a high-capacity battery with a battery capacity equal to or greater than 21 Ah, impregnation of the negative electrode active material layer with the non-aqueous electrolyte is reduced significantly.

In the present invention, a negative electrode protecting layer including insulating inorganic particles are provided on the negative electrode active material layer, and the porosity of the negative electrode protecting layer is equal to or greater than the porosity of the negative electrode active material layer. This improves impregnation of the negative electrode active material layer with a non-aqueous electrolyte including lithium bis(oxalato)borate and/or lithium difluorophosphate. As a result, the input/output characteristics, cycle characteristics and low temperature output characteristics of a high-capacity battery can be improved. Because the time required to impregnate the negative electrode active material layer with non-aqueous electrolyte is also significantly reduced, battery productivity can be improved.

Because a negative electrode protecting layer including insulating inorganic particles is formed on the negative electrode active material layer, a short circuit between the negative electrode and the positive electrode can be prevented, even when the separator insulating the negative electrode and the positive electrode has ruptured.

When the porosity of the negative electrode protecting layer is greater than the porosity of the negative electrode active material layer, impregnation of the negative electrode active material layer by the non-aqueous electrolyte can be further improved.

Here, the battery capacity is the discharge capacity (initial capacity) when the battery has been charged to a battery voltage of 4.1 V using 21 A of constant current, charged for 1.5 hours at a constant voltage of 4.1 V, and then discharged after charging to a battery voltage of 2.5 V at a constant current of 21 A. The charging and discharging was performed entirely at 25° C.

The porosity of the negative electrode active material layer is the volume ratio of the pores relative to the apparent volume of the negative electrode active material layer. In addition to directly measuring the porosity using the mercury intrusion technique, it can be determined from the real volume of the negative electrode active material layer calculated from the mass and true density of the components in the negative electrode active material layer, and the apparent volume of the negative electrode active material layer.

Similarly, the porosity of the negative electrode protecting layer is the volume ratio of the pores relative to the apparent volume of the negative electrode protecting layer. The porosity of the negative electrode protecting layer can be measured or determined in the same manner as that described above.

The porosity of the negative electrode protecting layer is preferably from 40 to 80%, and more preferably from 40 to 70%. When the porosity of the negative electrode protecting layer is within this range, the non-aqueous electrolyte more readily penetrates into the negative electrode protecting layer, and the negative electrode protecting layer can adequately hold the non-aqueous electrolyte.

The porosity of the negative electrode active material layer is preferably from 25 to 55%. Because a negative electrode protecting layer easily penetrated by the non-aqueous electrolyte is provided on the negative electrode active material layer, the non-aqueous electrolyte readily penetrates into the negative electrode active material layer via the negative electrode protecting layer. When the porosity of the negative electrode active material layer is within this range, a high energy density can be maintained in the negative electrode active material layer, and the negative electrode active material layer can adequately hold the non-aqueous electrolyte.

The thickness of the negative electrode protecting layer is preferably from 1 to 10 μm. If the negative electrode protecting layer is too thin, formation of the layer is difficult. If the negative electrode protecting layer is too thick, the energy density of the battery is reduced.

The porosity of the negative electrode protecting layer can be made greater than the porosity of the negative electrode active material layer by, for example, rolling only the negative electrode active material layer before the negative electrode protecting layer is formed.

In this non-aqueous electrolyte secondary battery, the amount of lithium bis(oxalato)borate included in the non-aqueous electrolyte may be from 0.05 to 0.20 mol/L, and the amount of lithium difluorophosphate included in the non-aqueous electrolyte may be from 0.01 to 0.10 mol/L. When the amount of lithium bis(oxalato)borate is too low, the input/output characteristic and cycle characteristic improving effect is insufficient. When more lithium bis(oxalato)borate is added, the upper limit on effectiveness is exceeded and the additional amount is not cost effective. This needlessly increases costs. When the concentration of lithium difluorophosphate is too low, the low temperature output characteristic improving effect is insufficient. When more lithium difluorophosphate is added, the upper limit on effectiveness is exceeded and the additional amount is not cost effective. This needlessly increases costs.

The negative electrode protecting layer can include insulating inorganic particles and an insulating binder to bind the particles together. The insulating inorganic particles can be at least one type selected from a group including alumina particles, magnesia particles, titania particles, and zirconia particles. The average particle diameter of the insulating inorganic particles is preferably from 0.1 to 10 μm, and more preferably from 0.1 to 5.0 μm.

The binder included in the negative electrode protecting layer can be any material commonly used in the field of non-aqueous electrode secondary batteries. Examples include fluorine-based binders such as polyvinylidene fluoride, tetrafluoroethylene, and acrylonitrile-based binders.

In this non-aqueous electrolyte secondary battery, the negative electrode has a negative electrode core exposing portion in which the negative electrode active material layer is not formed and in which the negative electrode core is exposed, and the negative electrode protecting layer is also provided in a region of the negative electrode core exposing portion contiguous with the negative electrode active material layer. In this configuration, the negative electrode protecting layer is positioned to the outside of the negative electrode active material layer. In this way, the non-aqueous electrolyte can first make contact with the negative electrode protecting layer, pass through the negative electrode protecting layer, and effectively migrate into the electrode assembly. This configuration can also prevent a short circuit between the positive electrode and the highly conductive negative electrode core exposing portion, even when conductive material has contaminated the electrode assembly.

In this non-aqueous electrolyte secondary battery, the electrode assembly may be a wound electrode assembly in which the positive electrode, negative electrode and an interposed separator are wound together. In a wound electrode assembly, the non-aqueous electrolyte has poor permeability because it can only penetrate into the electrode assembly from the two ends perpendicular to the winding axis of the electrode assembly. However, the present invention is very effective when used in a battery with a wound electrode assembly.

### Effect of the Invention

The present invention is able to provide with high productivity a non-aqueous electrolyte secondary battery having superior battery characteristics and a high capacity.

### BRIEF DESCRIPTION OF THE DRAWINGS

FIG. 1 is a perspective view of a non-aqueous electrolyte secondary battery according to the present invention.

FIG. 2 is a diagram showing the electrode assembly used in a non-aqueous electrolyte secondary battery according to the present invention.

FIG. 3 is a vertical cross-sectional view showing the positive and negative electrodes used in a non-aqueous electrolyte secondary battery according to the first embodiment of the present invention.

FIG. 4 is a vertical cross-sectional view showing the positive and negative electrodes used in a non-aqueous electrolyte secondary battery according to the second embodiment of the present invention.

### DETAILED DESCRIPTION

### Embodiment 1

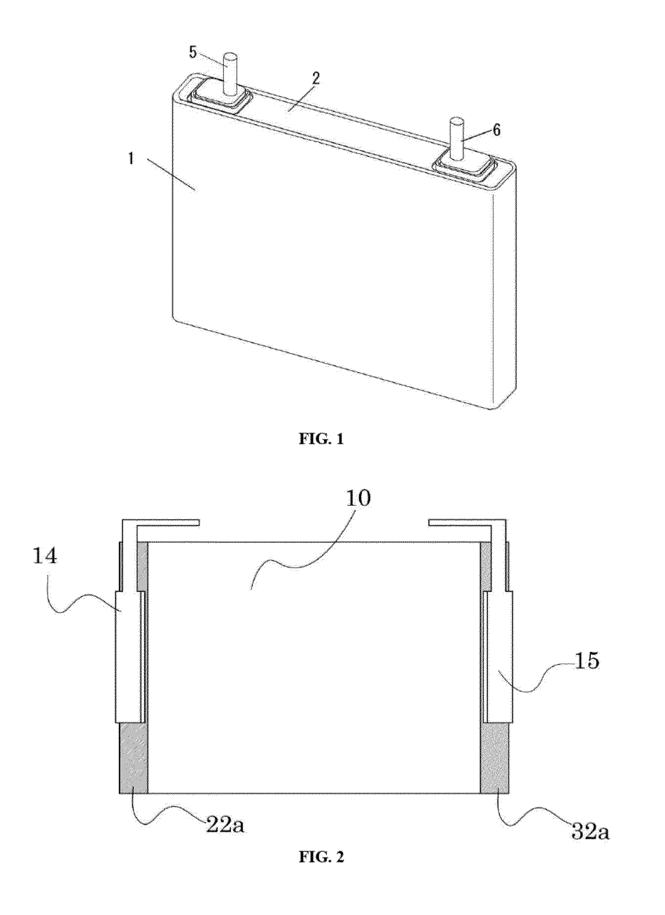

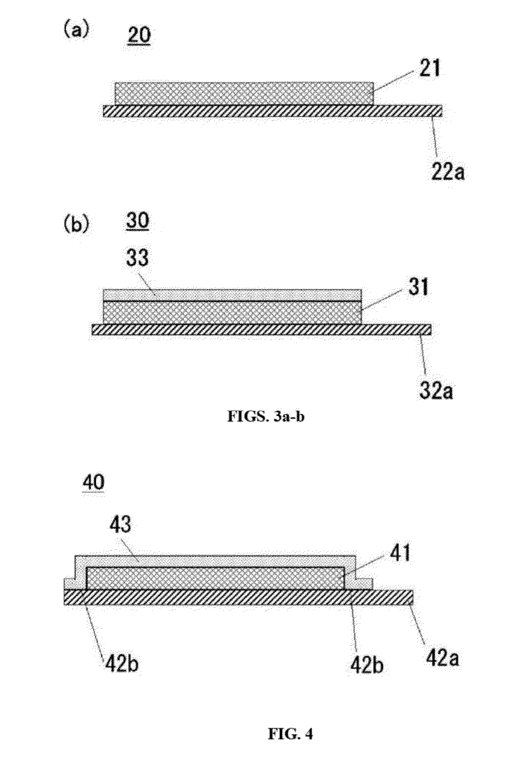

The following is an explanation with reference to the drawings of the battery of the present invention as applied to a lithium ion secondary battery. FIG. 1 is a perspective view of a lithium ion secondary battery according to the present invention, FIG. 2 is a diagram showing the electrode assembly used in the lithium ion secondary battery, and FIG. 3 is a vertical cross-sectional view showing the positive and negative electrodes used in a non-aqueous electrolyte secondary battery according to the first embodiment of the present invention.

As shown in FIG. 1, a lithium ion secondary battery of the present invention has a rectangular outer can 1 with an opening, a sealing plate 2 for sealing the opening in the outer can 1, and positive and negative electrode terminals 5, 6 protruding outward from the sealing plate 2.

Also, as shown in FIG. 3, the positive electrode 20 in the electrode assembly has a positive electrode core exposing portion 22a exposed on at least one end in the longitudinal direction of the band-shaped positive electrode core, and a positive electrode active material layer 21 formed on the positive electrode core.

The negative electrode 30 has a first negative core exposing portion 32a exposed on at least one end in the longitudinal direction of the band-shaped negative electrode core, and a negative electrode active material layer 31 formed on the negative electrode core. A negative electrode protecting layer 33 including insulating inorganic particles and an insulating binder is provided on the negative electrode active material layer 31.

In the electrode assembly 10, the positive electrode and the negative electrode are wound together via an interposed separator which is a microporous polyethylene membrane. As shown in FIG. 2, the positive electrode core exposing portion 22a protrudes from one end of the electrode assembly 10, the negative electrode core exposing portion 32a protrudes from the other end of the electrode assembly 10, the positive electrode collector 14 is mounted on the positive electrode core exposing portion 22a, and the negative electrode collector 15 is mounted on the negative electrode core exposing portion 32a.

This electrode assembly 10 is housed inside the outer can 1 along with the non-aqueous electrolyte, and the positive electrode collector 14 and the negative electrode collector 15 are connected electrically to external electrodes 5, 6 protruding from the sealing plate 2 while being insulated from the sealing plate 2 to extract current.

The non-aqueous electrolyte includes a non-aqueous solvent and an electrolyte salt dissolved in the solvent. Lithium bis(oxalato)borate and/or lithium difluorophosphate is added to the non-aqueous electrolyte. By using a non-aqueous electrolyte containing these, the input/output characteristics and the cycle characteristics of the battery can be improved.

When lithium bis(oxalato)borate and/or lithium difluorophosphate is added to the non-aqueous electrolyte, the viscosity of the non-aqueous electrolyte increases. In the present invention, the battery capacity equal to or greater than 21 Ah, and size of the negative electrode active material layer 31 in such a battery is especially large. Therefore, impregnation of the negative electrode active material layer 31 with the non-aqueous electrolyte is reduced significantly.

As shown in FIG. 3, the negative electrode protecting layer 33 including insulating inorganic particles and an insulating binder is provided on the negative electrode active material layer 31, and the porosity of the negative electrode protecting layer 33 is equal to or greater than the porosity of the negative electrode active material layer 31. This improves penetration of the negative electrode active material layer 31 by the non-aqueous electrolyte including lithium bis(oxalato)borate and/or lithium difluorophosphate. As a result, the input/output characteristics, cycle characteristics and low temperature output characteristics of a high-capacity battery can be improved. Because the time required to impregnate the negative electrode active material layer with non-aqueous electrolyte is also significantly reduced, battery productivity can be improved.

Because a negative electrode protecting layer 33 including insulating inorganic particles is formed on the negative electrode active material layer 31, a short circuit between the negative electrode and the positive electrode can be prevented, even when the separator insulating the negative electrode and the positive electrode has ruptured.

The porosity of the negative electrode protecting layer is preferably from 40 to 80%, and more preferably from 40 to 70%. In the non-aqueous electrolyte, the amount of lithium bis(oxalato)borate is from 0.05 to 0.20 mol/L, and the amount of lithium difluorophosphate is from 0.01 to 0.10 mol/L.

The ranges for the amount of lithium bis(oxalato)borate and lithium difluorophosphate included in the non-aqueous electrolyte are determined based on the non-aqueous electrolyte in the non-aqueous electrolyte secondary battery after assembly and before the first charge. The ranges are determined in this manner because the amount gradually decreases as the non-aqueous electrolyte battery containing lithium bis(oxalato)borate and/or lithium difluorophosphate is charged. This is believed to be caused by the consumption of some of the lithium bis(oxalato)borate and/or lithium difluorophosphate in the formation of film on the negative electrode during charging.

### Embodiment 2

FIG. 4 is a vertical cross-sectional view showing the positive and negative electrodes used in a non-aqueous electrolyte secondary battery according to the second embodiment of the present invention. In the negative electrode 40 of FIG. 4, the negative electrode protecting layer 43 is not only provided on the negative electrode active material layer 41 but also in a region 42b of the negative electrode core exposing portion contiguous with the negative electrode active material layer 41. Because the negative electrode protecting layer 43 is positioned to the outside of the negative electrode active material layer 41, the non-aqueous electrolyte can first make contact with the negative electrode protecting layer 43, pass through the negative electrode protecting layer 43, and effectively migrate into the electrode assembly. This configuration can also prevent a short circuit between the positive electrode and the highly conductive negative electrode core exposing portion, even when conductive material has contaminated the electrode assembly.

An embodiment of the present invention will now be explained with reference to examples. The present invention is not limited to the embodiments described above, and may be modified where appropriate within the spirit and scope of the invention.

### EXAMPLES

In the following examples, the non-aqueous electrolyte secondary battery shown in FIG. 1 through FIG. 3 was prepared.

### Example 1

### Preparation of Positive Electrode

A lithium-transition metal composite oxide (LiNi_{0.35}Co_{0.35}Mn_{0.3}O₂) serving as the positive electrode active material, carbon black serving as the conductive agent, and N-methylpyrrolidone (NMP) solution of polyvinylidene fluoride serving as the binder were kneaded together to obtain a positive electrode active material slurry with a lithium-transition metal composite oxide:carbon black:polyvinylidene fluoride solid mass ratio of 88:9:3.

After applying the positive electrode active material slurry to both sides of aluminum alloy foil serving as the positive electrode core (thickness: 15 μm), the slurry was dried to remove the NMP used as the solvent in slurry preparation and to form positive electrode active material layers on the positive electrode core. This was then rolled using a mill roll and cut to predetermined dimensions to complete the positive electrode 20. A positive electrode core exposing portion 22a was provided in the positive electrode 20 to expose the core in the longitudinal direction of the positive electrode core for connection to the positive electrode collector.

### Preparation of Negative Electrode

Natural graphite fashioned into round graphite particles, pitch and carbon black were mixed together to coat the surface of the round graphite particles with pitch and carbon black. The mass ratio of round graphite particles to pitch to carbon black in the mixture was 100:5:5 at this time.

The resulting compound was baked for 24 hours at 900 to 1,500° C. in an inactive gas atmosphere, and the baked product was ground and pulverized to obtain coated graphite particles in which the surface of the graphite particles was coated with a coating layer of amorphous carbon particles and an amorphous carbon layer.

A negative electrode active material slurry was prepared by kneading together the coated graphite particles, the flaky graphite, a carboxymethylcellulose (CMC) thickener, a styrene-butadiene rubber (SBR) binder, and water. The mass ratio of the graphite particles, the CMC and the SBR at this time was 98.7:0.7:0.6. The mass of the flaky graphite was 4.0% of the combined mass of the coated graphite particles and flaky graphite.

After applying the negative electrode active material slurry to both sides of copper foil serving as the negative electrode core 11 (thickness: 10 μm), the slurry was dried to remove the water used as the solvent in slurry preparation and to form negative electrode active material layers 31. This was then rolled using a mill roll, and cut to predetermined dimensions to complete the negative electrode active material layer 31. A negative electrode core exposing portion 32a was provided in the negative electrode 30 to expose the core in the longitudinal direction of the negative electrode core for connection to the negative electrode collector.

The porosity of the negative electrode active material layer was measured in the following manner. First, the packing density of the negative electrode active material layer was determined in the following manner. The negative electrode was cut to 10 cm², and the mass A (g) of the cut 10 cm² negative electrode and the thickness C (cm) of the negative electrode were measured. Next, the mass B (g) of the 10 cm² core and the thickness D (cm) of the core were measured. Finally, the packing density was determined using Equation (1):

Packing Density=(A−B)/[(C−D)×10 cm²] Equation (1)

Next, the true density of the negative electrode active material layer was calculated from the true densities of the graphite negative electrode active material, the binder and the thickener, and the porosity of the negative electrode active material was determined using Equation (2):

Porosity(%)=(1−packing density÷true density of the negative electrode active material layer)×100 Equation (2)

As a result, the porosity of the negative electrode active material layer was 47%.

Next, the negative electrode protecting layer 33 was formed on the negative electrode active material layer 31. A negative electrode protecting layer slurry was obtained by mixing together alumina particles having an average particle diameter (median diameter) of 0.7 μm as measured using a laser diffraction-type particle size distribution device (MicroTrak MT-3300EXII particle size analyzer), and a N-methylpyrrolidone solution of a resin containing C, H, O and N as the binder. This slurry was applied to the negative electrode active material layer 31 and dried to form the negative electrode protecting layer 33. The thickness of the negative electrode protecting layer 33 was 2 μm.

The porosity of the negative electrode protecting layer was determined in the following manner. The amount of alumina applied was measured using a X-ray fluorescence device, the volume of alumina was calculated from the true density of the alumina, and the porosity was calculated. As a result, the porosity of the negative electrode protecting layer was 61%.

### Preparation of Electrode Assembly

The positive electrode, the negative electrode and a polyethylene microporous membrane separator (thickness: 30 μm) were laid on top of each other so that the positive electrode core exposing portion 22a and the negative electrode core exposing portion 32a protruded from the three layers in opposite directions relative to the winding direction, and so that the separator was interposed between the different active material layers. The layers were then wound together using a winding machine, insulated tape was applied to prevent unwinding, and the resulting electrode assembly was flattened using a press.

### Connection of the Collectors to the Sealing Plate

An aluminum positive electrode collector 14 and a copper negative electrode collector 15 with two protrusions (not shown) on the same surface were prepared, and two aluminum positive electrode collector receiving components (not shown) and two copper negative electrode collector receiving components (not shown) with one protrusion on one surface were also prepared. Insulating tape was applied to enclose the protrusions of the positive electrode collector 14, negative electrode collector 15, positive electrode collector receiving components and negative electrode collector receiving components.

A gasket (not shown) was arranged on the inside surface of a through-hole (not shown) provided in the sealing plate 2, and on the outside surface of the battery surrounding the through-hole, and an insulating component (not shown) was arranged on the inside surface of the battery surrounding the through-hole provided in the sealing plate 2. The positive electrode collector 14 was positioned on top of the insulating component on the inside surface of the sealing plate 2 so that the through-hole in the sealing plate 2 was aligned with the through-hole (not shown) in the collector. Afterwards, the inserted portion of a negative electrode terminal 5 having a flange portion (not shown) and an inserted portion (not shown) was inserted from outside the battery into the through-hole in the sealing plate 2 and the through-hole of the collector. The diameter of the lower end of the inserted portion (inside the battery) is then widened, and the positive electrode collector 14 and the positive electrode terminal 5 were caulked to the sealing plate 2.

The negative electrode collector 15 and the negative electrode terminal 6 were caulked to the sealing plate 2 in the same way on the negative electrode side. In this operation, the various components were integrated, and the positive and negative electrode collectors 14, 15 and the positive and negative electrode terminals 5, 6 were connected conductively. In this structure, the positive and negative electrode terminals 5, 6 protruded from the sealing plate 2 while remaining insulated from the sealing plate 2.

### Mounting of the Collectors

The positive electrode collector 14 was arranged on the side of the flat electrode assembly with the core exposing portion of the positive electrode 11 so that the protrusion was on the side with the positive electrode core exposing portion 22a. One of the positive electrode collector receiving components is brought into contact with the positive electrode core exposing portion 22a so that the protrusion on the positive electrode collector receiving component is on the positive electrode core exposing portion 22a side, and so that one of the protrusions on the positive electrode collector 14 is facing the protrusion on the positive electrode collector receiving component. Next, a pair of welding electrodes is pressed against the back of the protrusion on the positive electrode collector 14 and on the back of the positive electrode collector receiving component, current flows through the pair of welding electrodes, and the positive electrode collector 14 and the positive electrode collector receiving component are resistance-welded to the positive electrode core exposing portion 22a.

Afterwards, the other positive electrode collector receiving portion is brought into contact with the positive electrode core exposing portion 22a so that the protrusion on the positive electrode collector receiving portion is on the positive electrode core exposing portion 22a side, and so that the other protrusion on the positive electrode collector 14 is facing the protrusion on the positive electrode collector receiving component. Next, the pair of welding electrodes is pressed against the back of the protrusion on the positive electrode collector 14 and on the back of the positive electrode collector receiving component, current flows through the pair of welding electrodes, and the positive electrode collector 14 and the positive electrode collector receiving component are resistance-welded a second time to the positive electrode core exposing portion 22a.

In the case of the negative electrode 30, the negative electrode collector 15 and the negative electrode collector receiving components are resistance-welded to the first negative electrode core exposing portion 32a in the same way.

### Preparation of Non-Aqueous Electrolyte

Ethylene carbonate, which is a cyclic carbonate, and ethyl methyl carbonate, which is a linear carbonate, were mixed together at a volume ratio of 3:7 (1 atm, 25° C.), and a lithium hexafluorophosphate (LiPF₆) electrolyte salt was dissolved in the resulting mixed solvent at a ratio of 1 mol/L. To the resulting solution were added vinylene carbonate at a concentration of 0.3 mass %, lithium bis(oxalato)borate at a concentration of 0.12 mol/L, and lithium difluorophosphate at a concentration of 0.05 mol/L to complete the non-aqueous electrolyte.

### Assembly of Battery

The electrode assembly 10 integrated with the sealing plate 2 was inserted into the outer can 1, the sealing plate 2 was fitted into the opening in the outer can 1, the welded portion of the outer can 1 was laser-welded around the sealing plate 2, a predetermined amount of non-aqueous electrolyte was poured in via a non-aqueous electrolyte hole (not shown) in the plate 2, the non-aqueous electrolyte hole was sealed, and the non-aqueous electrolyte secondary battery in the first example was complete.

### Comparative Example 1

The non-aqueous electrolyte secondary battery in the first comparative example was prepared in the same manner as the first example except that a negative electrode protecting layer was not provided on the negative electrode active material layer.

### Measurement of Battery Capacity

The battery capacities of the batteries in the first example and the first comparative example were measured in the following manner. The batteries were charged at a constant current of 21 A to a battery voltage of 4.1 V, and then charged for 1.5 hours at a constant current of 4.1 V. After charging, the batteries were discharged at a constant current of 21 A to a battery voltage of 2.5 V. The discharge capacity at this time was the battery capacity. As a result, the battery capacity of the battery in the first example was 24.9 Ah, and the battery capacity of the battery in the first comparative example was 24.7 Ah.

### Evaluation

### Room Temperature IV Measurement (Output)

The batteries in the first example and first comparative example were charged at 25° C. and at a constant current of 21 A to a state of charge (SOC) of 50%. Afterwards, the batteries were discharged for ten seconds each at constant currents of 1.6 It, 3.2 It, 4.8 It, 6.4 It, 8.0 It and 9.6 It. The battery voltages were measured, each current value and battery voltage was plotted, and the room temperature output voltage was determined (voltage W during a 3 V discharge). The results are shown in Table 1.

### Room Temperature IV Measurement (Regeneration)

The batteries in the first example and first comparative example were charged at 25° C. and at a constant current of 21 A to a state of charge (SOC) of 50%. Afterwards, the batteries were charged for ten seconds each at constant currents of 1.6 It, 3.2 It, 4.8 It, 6.4 It, 8.0 It and 9.6 It. The battery voltages were measured, each current value and battery voltage was plotted, and the room temperature output regeneration was determined (voltage W during a 4.3 V charge). The results are shown in Table 1.

In Table 1, the room temperature output values and room temperature regeneration values are relative values. Here, the values for the battery in the first comparative example are 100.

TABLE 1

| | | Room | Room |
|---|---|---|---|
| | Negative Electrode | Temperature | Temperature |
| | Protecting Layer | Output (%) | Regeneration (%) |
| Example 1 | Yes | 103 | 103 |
| Comparative | No | 100 | 100 |
| Example 1 | | | |

It is clear from Table 1 that the room temperature output and room temperature regeneration of the battery in the first example, in which the non-aqueous electrolyte contained lithium bis(oxalato)borate and lithium difluorophosphate, in which the surface of the negative electrode active material layer had a negative electrode protecting layer, and in which the porosity of the negative electrode protecting layer was greater than the porosity of the negative electrode active material layer, were improved to 103%, which is a value relative to the battery in the first comparative example, in which a negative electrode protecting layer was not provided on the surface of the negative electrode active material layer. It is believed that, because the porosity of the negative electrode protecting layer was greater than the porosity of the negative electrode active material layer, the non-aqueous electrolyte readily penetrated into the negative electrode protecting layer, the non-aqueous electrolyte was supplied from the negative electrode protecting layer to the negative electrode active material layer, and the impregnation of the negative electrode active material layer with the non-aqueous electrolyte was improved.

### Additional Details

The positive electrode active material can be one or more of the following: a lithium-containing nickel-cobalt-manganese composite oxide (LiNiₓCo_{y}Mn_{z}O₂, x+y+z=1, 0≦x≦1, 0≦y≦1, 0≦z≦1), a lithium-containing cobalt composite oxide (LiCoO₂), lithium-containing nickel composite oxide (LiNiO₂), a lithium-containing nickel-cobalt composite oxide (LiCoₓNi₁₋ₓO₂), a lithium-containing manganese composite oxide (LiMnO₂), spinel-type lithium manganese oxide (LiMn₂O₄), or a lithium-containing transition metal composite oxide in which some of the transition metal in the oxide has been substituted by another element (for example, Ti, Zr, Mg, Al, etc.).

The negative electrode active material can be a carbon material such as natural graphite, carbon black, coke, glassy carbon, carbon fibers, or baked products of these. These carbon materials can be used alone or in mixtures of two or more.

In addition to lithium bis(oxalato)borate and lithium difluorophosphate, one or more other lithium salts (base electrolyte salts) can be used as electrolyte salts. Examples include LiPF₆, LiBF₄, LiCF₃SO₃, LiN(CF₃SO₂)₂, LiN(C₂F₅SO₂)₂, LiN(CF₃SO₂)(C₄F₉SO₂)., LiC(C₂F₅SO₂)₃, LiAsF₆, LiClO₄, Li₂B₁₀Cl₁₀, Li₂B₁₂I₁₂, LiB(C₂O₄)F₂, and LiP(C₂O₄)₂F₂. The total concentration of electrolyte salts in the non-aqueous electrolyte is preferably from 0.5 to 2.0 mol/L.

The non-aqueous solvent can be one or more of the following: a high dielectric constant solvent in which lithium salts are highly soluble including a cyclic carbonate, such as ethylene carbonate, propylene carbonate, butylene carbonate or fluoroethylene carbonate, or a lactone such as γ-butyrolactone or γ-valerolactone; a linear carbonate, such as diethyl carbonate, dimethyl carbonate or ethyl methyl carbonate; or a low viscosity solvent including an ether, such as tetrahydrofuran, 1,2-dimethoxyethane, diethylene glycol dimethylethane, 1,3-dioxolane, 2-methoxytetrahydrofuran or diethyl ether; or a carboxylic acid ester, such as ethyl acetate, propyl acetate or ethyl propionate. A mixed solvent including two or more types of high dielectric constant solvent and low viscosity solvent can also be used.

Any well-known additive, such as vinylene carbonate, cyclohexyl benzene, and tert-amyl benzene can be added to the non-aqueous electrolyte.

A microporous membrane or membrane laminate of an olefin resin, such as polyethylene, polypropylene or a mixture thereof, can be used as the separator.

### INDUSTRIAL APPLICABILITY

As explained above, the present invention can provide with high productivity a non-aqueous electrolyte secondary battery having a high capacity and excellent battery properties, such as output and regeneration properties. Thus, industrial applicability is great.

### KEY TO THE DRAWINGS

1: Outer Can
2: Sealing Plate
5, 6: Electrode Terminals
10: Electrode Assembly
14: Positive Electrode Collector
15: Negative Electrode Collector
20: Positive Electrode
21: Positive Electrode Active Material Layer
22a: Positive Electrode Core Exposing Portion
30, 40: Negative Electrodes
31, 41: Negative Electrode Active Material Layers
32a, 42a: Negative Electrode Core Exposing Portions
33, 43: Negative Electrode Protecting Layer

What is claimed is:

1. A non-aqueous electrolyte secondary battery including a negative electrode and a non-aqueous electrolyte, the non-aqueous electrolyte secondary battery characterized in that the non-aqueous electrolyte includes lithium bis(oxalato)borate and/or lithium difluorophosphate, the negative electrode has a negative electrode core and a negative electrode active material layer formed on the negative electrode core, a negative electrode protecting layer including insulating inorganic particles is provided on the surface of the negative electrode active layer, the porosity of the negative electrode protecting layer is equal to or greater than the porosity of the negative electrode active material layer, and the battery capacity of the non-aqueous electrolyte secondary battery is equal to or greater than 21 Ah.

2. The non-aqueous electrolyte secondary battery according to claim 1, wherein the negative electrode has a negative electrode core exposing portion in which the negative electrode active material layer is not formed and in which the negative electrode core is exposed, and the negative electrode protecting layer is also provided in a region of the negative electrode core exposing portion contiguous with the negative electrode active material layer.

3. The non-aqueous electrolyte secondary battery according to claim 1, wherein the concentration of lithium bis(oxalato)borate is from 0.05 to 0.20 mol/L, and the concentration of lithium difluorophosphate is from 0.01 to 0.10 mol/L.

4. The non-aqueous electrolyte secondary battery according to claim 1, wherein the insulating inorganic particles is at least one type selected from a group including alumina particles, magnesia particles, titania particles, and zirconia particles.
